(19) United States
(12) Patent Application Publication
(10) Pub. No.: US 2026/0050859 A1
(43) Pub. Date: Feb. 19, 2026

(54) VISUALIZATION SYSTEM FOR REAL-TIME CONTEXTUAL EVENT NOTIFICATIONS

(71) Applicant: Verint Americas Inc., Alpharetta, GA (US)

(72) Inventors: Chris Schnurr, Derry (GB); Brendan Killen, Derry (GB); Marc Calahan, Alpharetta, GA (US); Senan Burgess, Dublin (IE)

(21) Appl. No.: 19/302,512

(22) Filed: Aug. 18, 2025

Related U.S. Application Data
(60) Provisional application No. 63/684,282, filed on Aug. 16, 2024.

(51) Int. Cl. G06Q 10/0639

(52) U.S. Cl. CPC G06Q 10/0639

(57) ABSTRACT

Embodiments of the present disclosure facilitate viewing and monitoring a plurality of real-time interactions simultaneously. In some embodiments, interactions are combined into multiple real-time event streams. An example system may present, in a user interface, event notifications and labels, wherein the event notifications and labels are used to monitor or intervene in interactions between the entities.

### CROSS-REFERENCE TO RELATED APPLICATIONS

This application claims priority to and the benefit of U.S. Provisional Application No. 63/684,282, titled “VISUALIZATION SYSTEM FOR REAL-TIME CONTEXTUAL EVENT NOTIFICATIONS”, filed on Aug. 16, 2024, the content of which is hereby incorporated by reference herein in its entirety.

### BACKGROUND

Conventional approaches to review individuals and assess whether or not they are engaged with problematic interactions are so-called “walk the floor” manual approaches by a supervisor. Other approaches are panic button or “raise hand” approaches which address only singular issues enacted directly from individual workers.

### SUMMARY

The present disclosure describes methods and systems for providing a visualization of interactions to an end-user, such as a supervisor in a contact center. Aspects of the disclosure enable an operator to view a number (e.g., 100+) of real-time interactions from a single internet browser web page. Building on prior art, these interactions are each combined of multiple real-time event streams.

In addition, aspects of the disclosure provide a visualization of real-time interactions where at least one side of the interaction is human-initiated. This visualization enables the operator (e.g., a supervisor) to determine which interactions are currently successful through scoring logic presented as visual icons. This visualization further enables the operator to determine which interactions have transitioned from a successful interaction to an unsuccessful or problematic, or harmful interaction through scoring logic presented as visual icons.

In addition, aspects of the disclosure enable the operator to subscribe to these transitions for key employees, to allow for pro-active alerts when such key employees encounter difficulties. Aspects of the disclosure enable the operator to listen in to any interaction underway. In addition, this visualization enables the operator to view the desktop screen of any interaction underway.

Yet further, this visualization enables the operator to review a textual categorization of any interaction underway. In addition, this visualization enables the ability to jump to any point in the transcript based on the phrases and textual categorizations detected. In addition, this visualization enables the operator to review a dynamic, textual transcript of any interaction underway. In addition, this visualization enables the operator to review a textual summary of any interaction underway, or completed, provided via artificial intelligence inference of the textual transcript (e.g., using one or more machine learning components).

In addition, this visualization enables the operator to send actionable content to the employees involved with any interaction underway, such as: “good job!” style comments, knowledge articles relevant to real-time context, or other contextual aid that helps with the ongoing interaction.

In addition, this visualization enables the operator to classify interactions based on the different event streams presented (i.e., text, voice, desktop, intent, subject, outcome).

In addition, this visualization enables the operator to filter and sort the interactions based on the above classifications.

In addition, this visualization enables the operator to mark or comment on filtered interactions for later review in pre-existing third party components such as quality management, training, or knowledge management.

In addition, this visualization enables the operator to subscribe to any classification, in order to receive notifications when interactions meet the classifications that have been configured.

In addition, this visualization enables the employee to “Raise a Hand” virtually to signal immediately to the operator that they are encountering difficulty.

In some implementations, a method of visualizing real-time contextual event notifications is provided. The method can include: receiving, at an Application Programming Interface (API) gateway component, event messages related to interactions between entities; processing, at a managed streaming component, the event messages to determine a context to generate event notifications; labeling the event notifications; and presenting, in a user interface, event notifications and labels, wherein the event notifications and labels are used to monitor or intervene in interactions between the entities.

In some implementations, a system is provided. The system can include: at least one processor; and a memory operably coupled to the at least one processor, the memory having computer-executable instructions stored thereon that, when executed by the at least one processor, cause the system to: receive, at an API gateway component, event messages related to interactions between entities; process, at a managing streaming component, the event messages to determine a context to generate event notifications; label the event notifications; and present, at a user interface, event notifications and labels, wherein the event notifications and labels are used to monitor or intervene in interactions between entities.

In some implementations, a non-transitory computer readable medium is provided. The non-transitory computer readable medium can include instructions that, when executed by a processor of a processing system, cause the processing system to perform a method for processing an audio input, including instructions to: receive, at an API gateway component, event messages related to interactions between entities; process, at a managing streaming component, the event messages to determine a context to generate event notifications; label the event notifications; and present, at a user interface, event notifications and labels, wherein the event notifications and labels are used to monitor or intervene in interactions between entities.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1A illustrates an overview of the components of the real-time contextual event notification system according to certain embodiments;

FIG. 1B illustrates an overview of the components of the contextual event notification system according to certain embodiments;

FIG. 2 illustrates additional details of the recorder integration server and cloud-based recorder and a call event API that is utilized to convey event data according to certain embodiments;

FIG. 3A is a flowchart diagram illustrating an example method according to certain embodiments;

FIG. 3B illustrates the data flow associated with a notification event API according to certain embodiments;

FIG. 4 illustrates a work-flow of the components within a client management service (CMS) according to certain embodiments;

FIG. 5A illustrates a call flow diagram of communication between the components of FIG. 4 according to certain embodiments;

FIG. 5B and FIG. 5C are operational examples showing graphical user interfaces/elements according to certain embodiments; and

FIG. 6 is an example computing system.

### DETAILED DESCRIPTION

### System Overview

Modern contact centers utilize omnichannel communications to connect customers with support agents over communication channels, such as e-mails, live chat, social media, Short Message Service (SMS) messaging, and support tickets, to create a seamless user experience. Transaction history of the customer interactions over the various channels is maintained by the contact center. For example, if a customer initiates a chat session, the information from the chat session is available to a live support agent should the customer decide to ask to speak with a support agent while chatting. Customer interactions within the contact center may be viewed as a system of many parallel streams of events occurring in real-time. On their own, each event stream only describes a small fraction of the activity within the overall system, but when combined in a fully scalable and resilient manner in accordance with the disclosure hereinbelow, complex business rules may be holistically applied to the system. Further, a context may be derived from each event stream in real-time. This derived context allows for complex decisions to be made, and the associated outcomes provided to support agents to assist in decision making in order to achieve a desirable outcome to address a customer's purpose for contacting the contact center.

### Architecture Description

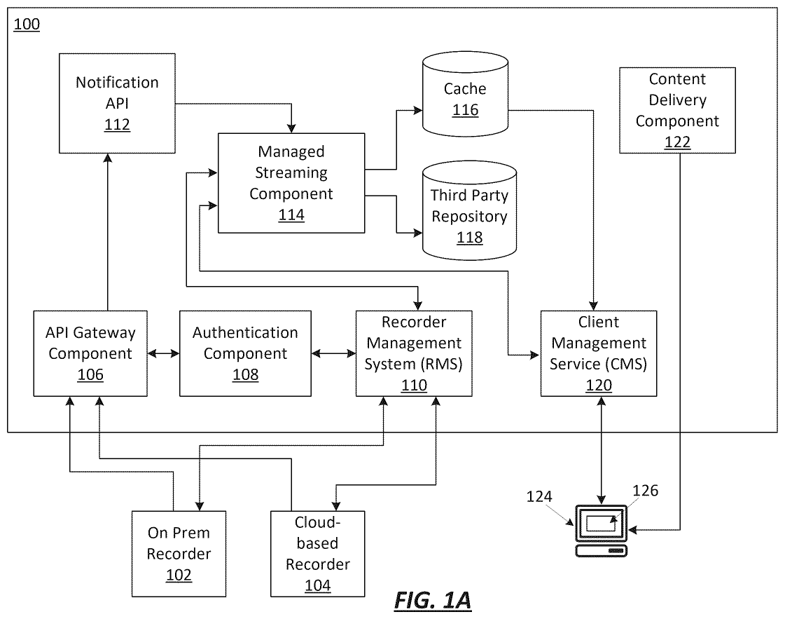

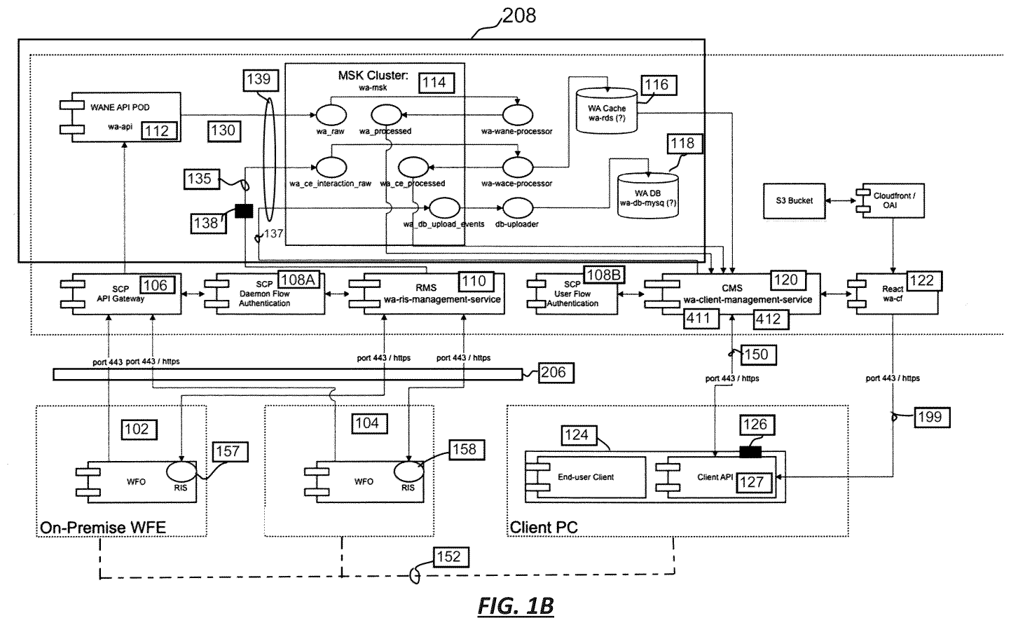

Referring to FIGS. 1A and 1B, there is illustrated an overview of a real time contextual event notification system 100, its components, services, and processes according to certain embodiments. In an implementation, the real time contextual event notification system 100 is a cloud-based real time messaging system that ingests event streams (e.g., notification events 130, call events 135, and real time call data 137 shown in FIG. 1B) as streams from any authorized entity, determines a context of a support agent and provides notifications to the support agent in accordance with the context data. The event streams may come from multiple sources, and rules may be applied to provide real time contextual event notifications that are event notifications associated with a condition or state of a user, a state of a particular call at a client device, and a circumstance that generated the event stream (for example, a support agent interaction with a customer), such as, “only show this message when the user is no longer on a phone call,” “wait until the user stops editing this document before showing the next message,” or “only show this information when the user starts speaking to a customer and they open a particular sub-menu and the customer has mentioned a particular key word.”

Sources of event streams provided to the real time contextual event notification system 100, may include on-premises servers (for example, a recorder integration server 102 available from Verint Systems, Inc. of Melville, NY) and cloud-centric servers (for example, a cloud-based recorder server 104). The recorder integration server 102 and/or cloud-based recorder server 104 may capture call status information (call awareness data), audio (linguistic events), and screen activity (application events) associated with communications conducted between the customer and the support agent. The communications may occur on multiple channels, including but not limited to, telephone calls, wireless communications of all kinds, texts, chats, emails, voicemails, videos, teleconferences and the like. The video, audio and screen activity may be recorded so that it can be evaluated according to business needs. In an implementation, events may be messaged to the real time contextual event notification system 100 in accordance with rules applied to the source of the captured activity to provide context information for a particular call scenario, including call state awareness events, linguistic events and application events.

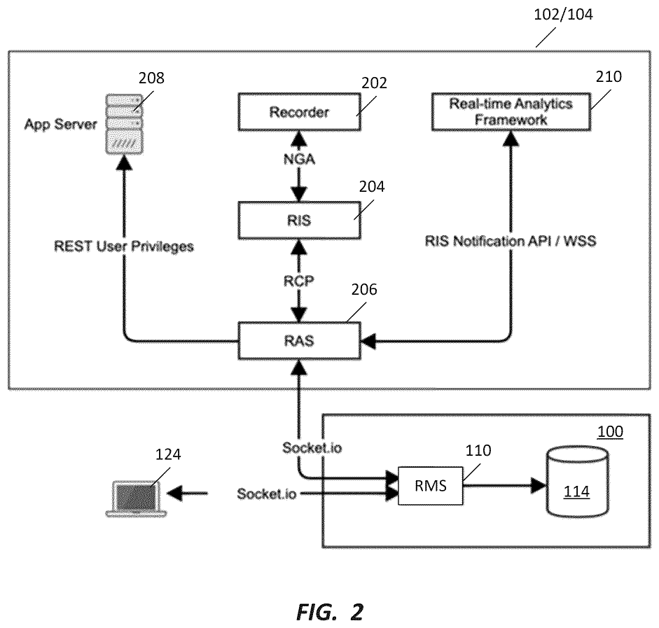

Linguistic events are determined, for example, not only from real time communication analysis, but also from speech-to-text transcripts of audio conversation(s) conducted between customers and support agents. If the communications are not already in textual format, in some embodiments, transcripts of the communications are analyzed by a real time analytics framework (see, FIG. 2) to identify the grouping and organization of the words and phrases spoken during calls that meet certain classification criteria. The analysis may identify themes that reveal trends and areas of opportunity or concern.

Application events are determined, for example, as a customer or support agent interacts with a user interface. For example, a user interface component may capture keystrokes, mouse clicks, screen touches, data submissions, etc. Each interaction with the user interface may be considered an application event and the real time analytics framework may use this information to determine how the customer and/or agent is interacting with an application presented in the user interface.

Call states allow the system to know the current activity on an agent communications port. When providing event notifications to an end user, the state of the call (on hold, active, terminated, etc.) can help determine what kind of notifications are useful at that point.

In an implementation, rules to manage the event notification system 100 are distributed among the various connected sources. In another implantation, the rules may be centralized within the real time contextual event notification system 100 and applied to the event messages that are received from various sources. A hybrid approach may also be used where rules are applied at the source(s) and at the real time contextual event notification system 100.

A recorder management system (RMS) 110 serves as an endpoint to which the recorder integration server 102 and/or cloud-based recorder server 104 interface connect, for example, over a socket connection. The RMS 110 assists in managing the connections of the local, on-premises recorder server 102 and/or cloud-based recorder server 104, and, together with an authentication component 108, may authenticate incoming connections, process incoming messages, validate the schema of an incoming message, and validate the data passed in the message by adding a token to each message. In non-limiting embodiments, the authentication component 108 uses a “Daemon Flow” authentication mechanism to enable the socket to be connected irrespective of the location of the recorder (i.e., on-premises or in the cloud). The RMS 110 may receive interaction and analytics events from the recorder integration server 102 and/or cloud-based recorder server 104 that are used to, for example, determine the context of an interaction between the customer and the agent.

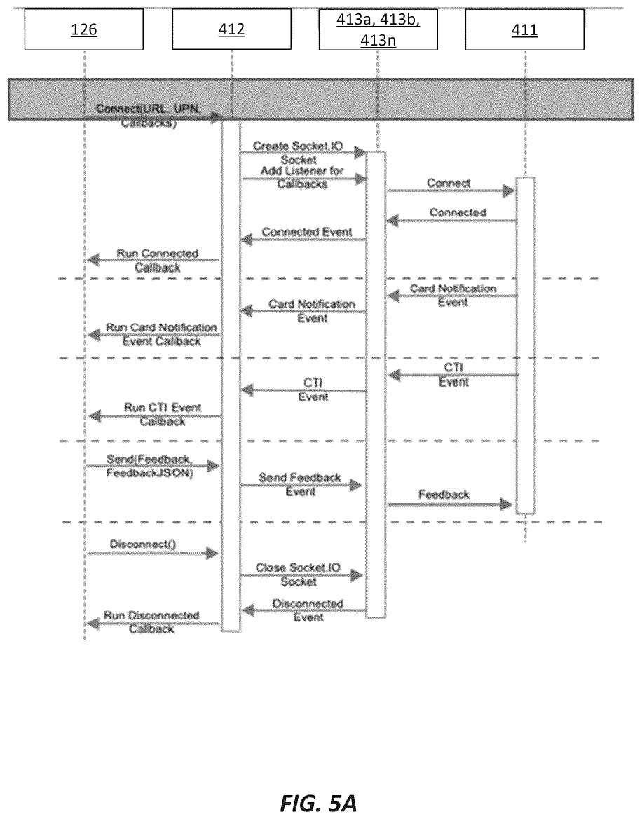

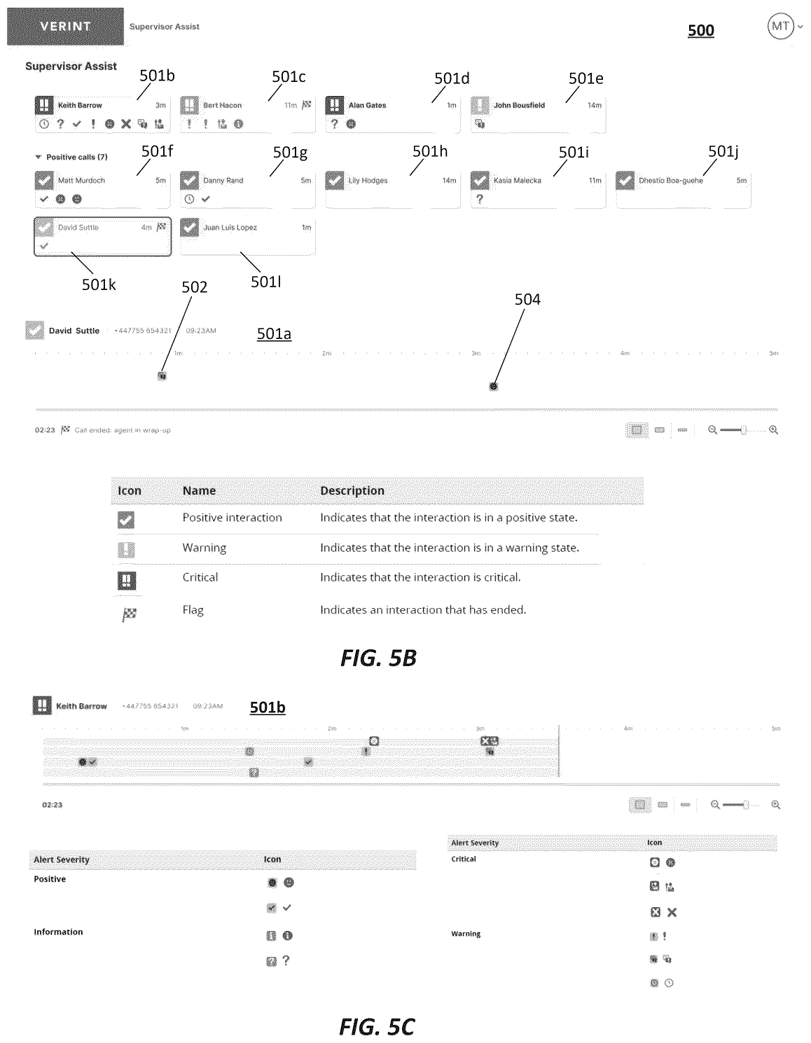

This disclosure utilizes both a web socket connection application programming interface (API) 412 and a RESTful API 112 to provide dual functionality in receiving parallel event streams according to this disclosure. As shown in FIG. 1B, real time communications data (e.g., call data) 150 is provided to a cloud-based client management service 120 via a socket network system (e.g., socket.io server 411) and web socket connection API 412. This communications data 150 may be a direct input 137 to a managed stream component 114. Also, the fact that original communications data 150 is ready to be received from an active call at the end user device 124 sets off a chain of events that allows the event notification system 100 to implement its work assist notification bus (collectively 139) with fully authenticated data. On the socket level, and shown further in FIGS. 1B and 5, the original communications data 150 is authenticated by a desktop authentication protocol as a user flow authentication 108B. As shown in FIGS. 1A, FIG. 1B, and FIG. 2, the original communications data 150 may be additionally directed to workflow enhancement operations 152 utilizing an on-premises recorder server 102 and/or cloud-based recorder server 104. The original communications data 150 that has traversed the various servers utilizes a web socket connection API 412 to initiate a Daemon Flow authentication 108A, with the goal being additional communications to the RESTful API endpoint 112 in the work assist agent server 208. In one non-limiting embodiment, the web socket connection API 412 is in communication with the client management system 120 and gives the client management server 120 access to original communications data 150 (such as raw call data 137), while the RESTful API 112 operates on application data 130, call event data 135, and linguistic inputs discussed below that are collected from an entity's recording integrations server 204 via a recording management system RMS 110.

The on-premises recorder server 102 and/or cloud-based server 102, 104 may include or be connected to respective recorder integration servers (RIS) 157, 158, referred to generally in FIG. 2 as RIS 204. FIG. 2 notably illustrates how the web socket connection API 412, and the web socket inputs and outputs may be in communication with recorder hardware, such as the RIS 204 and an associated Recorder Archive Server (RAS) 206. The RIS 204 can be configured to send organizational and operational data along with integration data. Operational data can include appropriate data to enable the client side visualization to lookup and connect to internal and external third-party services that are associated with one or more interactions. FIG. 2 also illustrates how the RAS may house libraries of REST user privileges that are then directed to an overall work assist agent server 208 (i.e., an agent server that provides work assist notifications and messages to an end user client computer 124). In other words, the web socket connection API 412 is tied to original communications data 150 being actively communicated to any one or all of a client management system 120, an on-premises recorder integration server 157 or a cloud recorder integration server 158 having respective recorder systems. When the web socket connection API 412 has been authenticated at the client management system 120, then the RESTful API can retrieve REST user privileges associated with that communications data 150 to initiate the Daemon Flow authentication 108A. The Daemon Flow authentication allows the work assist server 208 to implement value added computational services to make the output messages 199, delivered to each agent end user client device 124, more robust.

The recorder integration server 102 and/or cloud-based recorder server 104 communicate with an API gateway component 106 that accepts a real time events stream as event messages over a socket connection from the recorder integration server 102 and/or cloud-based recorder server 104. The event messages include the token provided by the authentication component 108. Authenticated event messages are forwarded from the API gateway component 106 to a notification API 112 that provides a RESTful API to connect the event messages to a managed streaming component 114. In particular, received event messages are added to an event bus of the managed streaming component 114 and organized by topic. This sequence is used as shown in FIG. 1B for application events and certain call events like audio and linguistic analyses. Other processes could be added as developed.

The managed streaming component 114 provides services to publish (write) and subscribe to (read) streams of events, including continuous import/export of data from other systems. The managed streaming component 114 stores streams of events into a cache 116 or third-party repository 118. The managed streaming component 114 may process event streams as they occur (i.e., in real time) or retrospectively. An example managed streaming component 114 is Apache KAFKA. The managed streaming component 114 processes the received event streams by organizing the events contained therein by raw topic, for example, a category of interest by which event message data is stored and published. The managed streaming component 114 uses information contained in call event messages provided by the RMS 110 or the CMS 120 to determine a current state of a call associated with an event stream. The call state information may be provided by the recorder integration server 102 and/or cloud-based recorder server 104 to the RMS 110 during a call between the customer and the support agent. The managed streaming component 114 stores the most current event of the call(s) and event streams (event message data and call event message data) to the cache 116 by topic for consumption by a client management system (CMS) 120 for delivery to a client 124 (and/or clients as described below as 124a, 124b, 124n).

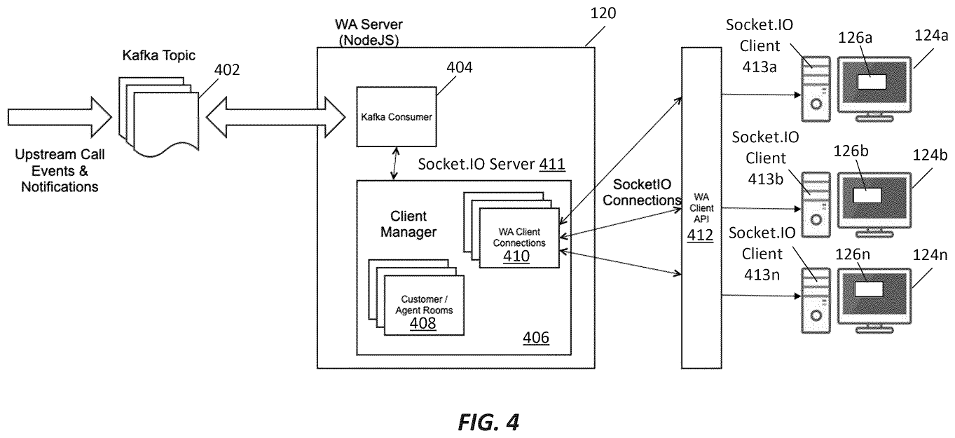

The CMS 120 is an API designed to wrap around Socket.IO server 411 for the handling of commands to interact with the system 100 and to receive/send events. The CMS 120 provides a flexible interface to allow third parties to the system 100 to implement their own event client application. API calls to the CMS 120 are suitably generic in that they can be extended without the need to redistribute entire new package versions. Although according to certain embodiments this package may be written in JavaScript, in other embodiments the package may be written in Dart, CoffeeScript, TypeScript, ELM, Kotlin, ClojurScript, or other web development language capable of encoding one or more features described herein. FIGS. 1B and 5 show an example of a general flow of communication between a work assist application at the work assist server 208 that communicates with a socket IO server 411. The socket IO server 411 is in communication with or housed within the client management system 120 consuming the work assist data, coaching, and notifications for display at a client device. The data from the work assist server 208 is directed to respective socket IO client connections 413 via a web socket connection API 412, that may operate at the on-premises recorder server 102 or a cloud-based recorder server 104, to provide the work assist data, coaching, and notifications to various end users 124. In a different embodiment shown in FIG. 4, the client management system 120 and the socket.io server 411 are actually connected to or housed with the work assist server 208. The placement of servers shown in the figures is not limiting of this disclosure and other arrangements are within the scope of this disclosure.

A content delivery component 122 is provided to create a user interface to be presented on a client 124. The content delivery component 122 may be provided as JavaScript libraries that are interpreted by a plugin on a client application 126 (for example, a browser) executing on the client 124 to render the user interface. The client application may be cross-platform to enable easy distribution to any client 124. Target users connect to the real time contextual event notification system 100 via a web application hosted in a native browser or desktop electron application.

With the introduction above of the various components within the real-time contextual event notification system 100, each will now be described in greater detail with reference to FIGS. 2-6.

### Recorder Integration Server 102/Cloud-Based Recorder 104

With reference to FIG. 2, there are illustrated additional details of the recorder integration server 102 and cloud-based recorder 104 according to certain embodiments. A call event socket connection is utilized to convey event data from the recorder integration server 102 and cloud-based recorder 104 to the RMS 110. The call event Web socket is connected to the RMS 110 and receives an event stream from a Recorder Integration Server (RIS) 204 residing within the recorder integration server 102 and/or cloud-based recorder 104. This event stream is added to the real-time contextual event notification system 100 to allow for context provided by a call recorder 202 to be used to influence notifications provided to an agent and client interface states.

In operation, as a customer conducts a voice communication session with an agent, the call recorder 202 records audio and screen interaction data to enable search, replay, and report on calls by topic. The call recorder 202 communicates with the RIS server 204 as it records the calls and screens data. The RIS server 204 communicates to a Recording Archive Service (RAS) 206, which creates a socket connection to the RMS 110 to make the call event API call and pass event data to the system 100. The call event API is bidirectional to enable feedback and control of the RIS server 204 from client 124.

An event service within an agent server 208 is registered as a part of the startup sequence of AgentServerService. This service receives interaction and analytics events from a real-time analytics framework 210 for calls and sends them to the system 100 via a Socket.IO connection with the RMS 110. The RMS 110 is the endpoint for the RAS Socket.IOconnections. The interaction and analytics events may be derived from acoustic analytics, linguistic analytics (for example, keywords and sentiment analysis from transcripts), biometric analytics (for example, does the person on the phone match a voice print), and desktop analytics.

When the event service starts, a list of configured tenants is obtained in order to maintain segregation of data when communicating with the RMS 110. Each tenant will have its own Socket.IO connection to the RMS 110 on a 1:1 basis. Once the list of tenants is known, the event service looks for configuration to see if the event notification is configured. This information may be contained in a configuration file, for example,

“INTEGRATION_FRAMEWORK-conf.xml,” as shown below:

| | |
|---|---|
| 1 | <External> |
| 2 | <CloudConfig> |
| 3 | <EXT_VCS xmlns=“http://www.verint.com/EM/Metadata/2008/Roles/EXT_VCS” |

role:instanceID=“855040” role:roleName=“EXT_VCS” role:Identity=“211”>

| | |
|---|---|
| 4 | <EXT_VCS_SETTINGS> |
| 5 | |
| | <AZURE_AUTH_SCOPE>ws://application/api/auth/.default</AZURE_AUTH_SCOPE> |
| 6 | <WA_URL>https://RegionalURL/LoadBalance/Address</WA_URL> |
| 7 | <WA_UPN>Username</WA_UPN> |
| 8 | </EXT_VCS_SETTINGS> |
| 9 | </EXT_VCS> |
| 10 | </CloudConfig> |
| 11 | </External> |

If the CloudConfig settings to successfully communicate to system 100 are not configured for any tenants, the service does not register listeners for notifications (for example, interactions and analytics events). The CloudConfig settings also contain information to pass the Verint Cloud Platform (VCP) Authentication Configuration to the correct cloud instance. The VCP Authentication Config is parsed from the SecuritySettings.xml file by obtaining the VCPAuthentication element, decoding it using base64 URL decoding, and then decrypting it using the CCL (AES256) decryption. The VCP Authentication Config is configured on a per-tenant basis, which means that each connection to the WA server has its own set of credentials.

When receiving interaction or analytics events from the real-time analytics framework 210, a map of Session ID to Tenant IDs is populated from interaction messages to allow analytics events that do not have an explicitly set Tenant ID to be sent onward using the correct socket.IOconnection. This allows a lookup of analytics events based on the Session ID. This map is cleaned up when receiving a call end interaction message.

Provided a message has a tenant, it is then checked for a user principal name (UPN). If no UPN is present, the message is unable to be sent to a client who is logged into WA and is therefore not sent. If a message does have the Tenant ID and the UPN, it is passed to the SocketloManager in order to be sent to WA using the correct socket.IOconnection.

The SocketloManager contains a single executor that queues the work of sending messages via the socket.IOconnection for a given tenant. On startup and on configuration refresh, the map of Tenant to Socket.IO connections is created, and the connections themselves are established. Each of these connections requires the configuration from the VCP Authentication Config. The configuration here allows for fetching of the access token that is used when creating a Socket.IOconnection to the RMS 110.

The individual connections managed by the SocketIOManager are contained within SocketloConnection. These connections directly handle the communication and connection to the RMS 110. When connecting to the RMS 110, there is a two-phase connection, where an initial connection begins with very basic communication. It listens for events on the following keywords: “Connect,” “tenantInformation,” “disconnect,” “connect_error,” “reconnect,” “reconnect_attempt,” and “event_close”. This initial connection is to establish a connection to the RMS 110 and receive the “tenantInformation.” This is done by the RMS 110 parsing the authentication token and the RMS 110 responding with a tenant. Once this information has been passed back to the SocketloConnection, the second phase commences by creating a new namespace Socket.IOconnection. Any information sent to the RMS 110 is communicated via this new tenant-based namespace socket.

### Example Method

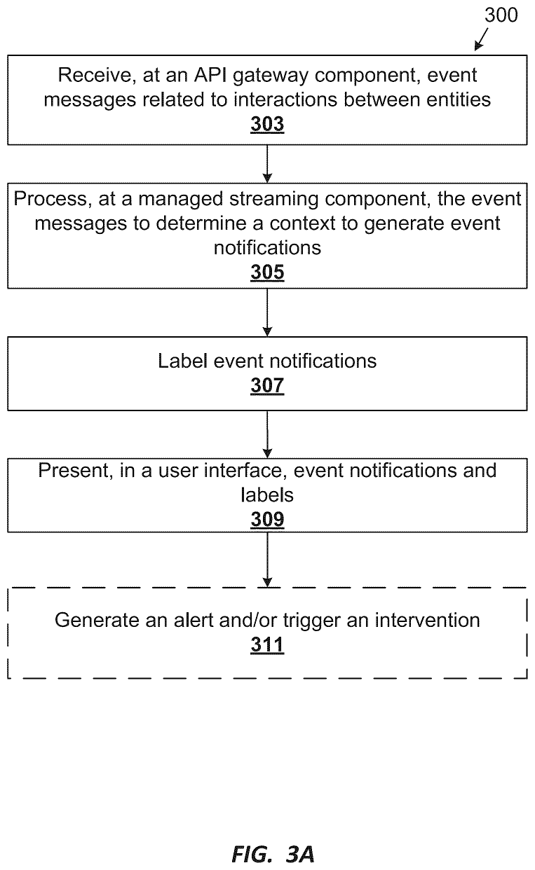

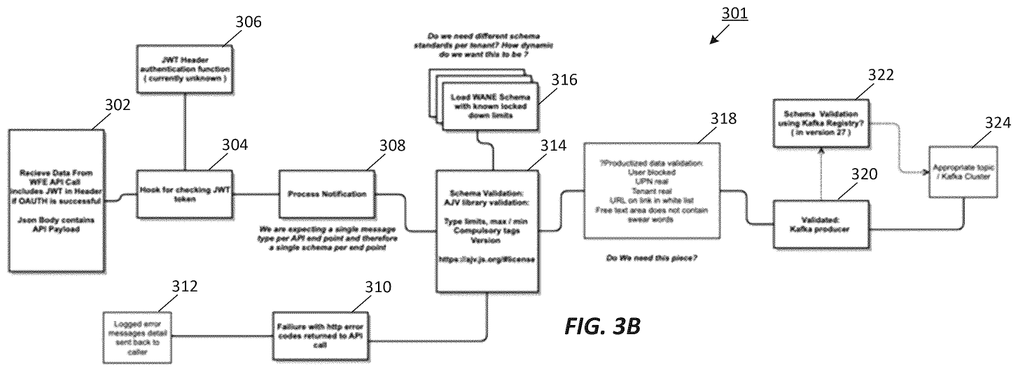

FIG. 3A is a flowchart diagram illustrating an example method 300 that can be used for monitoring and intervening in interactions in real-time in accordance with various implementations described herein. The method 300 can be at least partially implemented using some or all of the components of the systems described above in connection with FIG. 1A, FIG. 1B, and FIG. 2.

At step/operation 303, the method 300 includes receiving, at an API gateway component, event messages related to interactions between entities.

At step/operation 305, the method 300 includes processing, at a managed streaming component, the event messages to determine a context to generate event notifications.

At step/operation 307, the method 300 includes labeling the event notifications.

At step/operation 309, the method 300 includes presenting, in a user interface, event notifications and labels, wherein the event notifications and labels are used to monitor or intervene in interactions between the entities. In some implementations, step/operation 309 includes scoring the event notifications and presenting scored event notifications as visual icons. An end-user can subscribe to event notifications for one or more specific entities (e.g., employees or agents), listen to an interaction, and/or view a desktop screen of an interaction. In some embodiments, a user can view a desktop screen showing an interaction and review a textual categorization or a dynamic, textual transcript of an interaction. In one example, an end-user can jump (e.g., manually or automatically) to any point in a textual transcript based on detected phrases and textual categorizations. The user interface can enable an entity to review a textual summary of an interaction provided (e.g., generated) using artificial intelligence inference (e.g., via one or more machine learning components) of a textual transcript. The system can enable an end-user to classify interactions based on different presented event streams and/or filter and sort through interactions based on the classifications.

Optionally, at step/operation 311, the method 300 includes generating an alert and/or triggering an intervention. Exemplary interventions can include outputting a message to an agent's display to prompt the agent to escalate the interaction, transfer the call, and/or automatically connect to another entity (e.g., supervisor) to provide assistance.

### Notification Event API 112

Referring to FIG. 3B, there is illustrated a description of the data flow 301 associated with the notification event API 112 according to certain embodiments. At 302, the notification API 112 receives a message from a source, for example, the recorder integration servers 102 and/or cloud-based recorder 104. The source of the message includes the authentication token in the header of the message. At 304, the token is checked by the notification API 112. An authentication function 306 is used to perform the check at 304. At 308, the message is processed. The notification API 112 assumes a single message format which is matched against a single schema at 314. The schema itself may be in the form of a JSON file and is loaded up when initializing the library prior to beginning to accept messages. In operation, the library is asked to check each incoming message and responds by giving the message object a pass/fail. For messages that fail validation, the library returns HTTP error codes to the sender at 310, and the library makes available a detailed list of the validation errors found at 312. For example, the message sender may be sent an HTTP error code 400 (BAD REQUEST) to assist in troubleshooting.

At 318, data validation is performed. The notification API 112 may check to determine if the user is blocked, UPN is real, the tenant is real, the URL on a link is on a waitlist, a free text area does not contain any swear words, etc. At 320, the validated data is sent to the managed streaming component 114, which may perform schema validation at 322. Once validated, it is determined that the message is an appropriate topic to be placed into the managed streaming component 114 for further analysis.

Below is an example non-limiting notification payload design. Other notification payload designs consistent with the teaching below are considered to be within the scope of the present disclosure and claims.

```
{
      “upn”: “bob@bob.com”,
      “title”: “Here I am”,
      “iconType”: “information”,
      “message”: “How do you do”,
      “feedback”: {
        “positive”: [
          “Good”,
          “Great”,
          “Excellent”
        ],
        “negative”: [
          “Bad”,
          “Awful”,
          “Terrible”
        ],
        “showFeedback”: true
      },
      “actions”: {
        “content”: [
          {
            “Google”: “aHR0cDovL3d3dy5nb29nbGUuY29t”
          },
          {
            “Amazon”: “aHR0cHM6Ly93d3cuYW1hem9uLmNvbQ==”
          }
        ],
        “styledAsLinks”: true
      },
      “expiryDuration ”: 300,
      “highlightedDuration”: 30,
      “timeOfEvent”: “2021-12-09T11:31:05.442Z”,
      “timeEventDetected”: “2021-12-09T11:31:06.225Z”
    }
  ],
  “properties”: {
    “upn”: {
      “$id”: “#/properties/upn”,
      “type”: “string”,
      “format”: “no-script-string”,
      “title”: “upn is in an email format.”,
      “description”: “upn is used to define what user the message goes to.”,
      “minLength”: 6,
      “maxLength”: 255,
      “examples”: [
        “hpalumbo0@free.fr”
      ]
    },
    “title”: {
      “$id”: “#/properties/title”,
      “title”: “The title of a notification”,
      “description”: “Title of event for display for message.”,
      “type”: “string”,
      “format”: “no-script-string”,
      “minLength”: 1,
      “maxLength”: 255,
      “examples”: [
        “Berlin Alexanderplatz”
      ]
    },
    “iconType”: {
      “$id”: “#/properties/iconType”,
      “type”: “string”,
      “format”: “no-script-string”,
      “title”: “The icon type”,
      “description”: “Icon type to display on an event.”,
      “default”: “information”,
      “enum”: [“information”, “confirmation”, “error”, “warning”, “question”,
      “overTalk”, “sadFace”, “happyFace”,
“escalation”, “clock”],
      “examples”: [
        “information”
      ]
    },
    “message”: {
      “$id”: “#/properties/message”,
      “type”: “string”,
      “format”: “no-script-string”,
      “title”: “The message body”,
      “description”: “Content message of event to display.”,
      “default”: “ ”,
      “minLength”: 0,
      “maxLength”: 2000,
      “examples”: [
        “Cras mi pede, malesuada in, imperdiet et, commodo vulputate, justo.”
      ]
    },
    “feedback”: {
      “$id”: “#/properties/feedback”,
      “type”: “object”,
      “title”: “The feedback object”,
      “description”: “Used to configure the feedback of a notification.”,
      “default”: { },
      “examples”: [
        {
          “feedback”: {
            “positive”: [
              “Good”,
              “Great”,
              “Excellent”
            ],
            “negative”: [
              “Bad”,
              “Awful”,
              “Terrible”
            ],
            “showFeedback”: true
          }
        }
      ],
      “properties”: {
        “positive”: {
          “$id”: “#/properties/positive”,
          “type”: “array”,
          “title”: “The positive array”,
          “description”: “Items that will be displayed as positive items on
          a notification.”,
          “default”: [ ],
          “items”:
            {
              “type”: “string”,
              “format”: “no-script-string”,
              “minLength”: 0,
              “maxLength”: 500
            }
        },
        “negative”: {
          “$id”: “#/properties/negative”,
          “type”: “array”,
          “title”: “The negative array”,
          “description”: “Items that will be displayed as negative items on
          a notification.”,
          “default”: [ ],
          “items”:
            {
              “type”: “string”,
              “format”: “no-script-string”,
              “minLength”: 0,
              “maxLength”: 500
            }
        },
        “showFeedback”: {
          “$id”: “#/properties/showFeedback”,
          “type”: “boolean”,
          “title”: “The showFeedback control”,
          “description”: “This controls if the up and down feedback buttons
          are displayed for a notification.”,
          “default”: true,
          “examples”: [
            false
          ]
        }
      }
    },
    “actions”: {
      “$id”: “#/properties/actions”,
      “type”: “object”,
      “title”: “The actions list”,
      “description”: “Actions that can be displayed on a notification.”,
      “default”: { },
      “examples”: [
        {
          “actions”: {
            “content”: [
              {
                “Google”: “aHR0cDovL3d3dy5nb29nbGUuY29t”
              },
              {
                “Amazon”: “aHR0cHM6Ly93d3cuYW1hem9uLmNvbQ==”
              }
            ],
            “styledAsLinks”: true
          }
        }
      ],
      “properties”: {
        “content”: {
          “$id”: “#/properties/content”,
          “type”: “array”,
          “title”: “The content to be listed”,
          “description”: “Content items that can be displayed on a notification.”,
          “default”: [ ],
          “items”:
            {
              “$id”: “#/properties/content/item”,
              “type”: “object”,
              “title”: “The content item”,
              “description”: “Key value pairs of a content item that contains
a display name and a base64 encoded URL.”,
              “additionalProperties”: {
                “type”: “string”,
                “format”: “no-script-string”
              },
              “examples”: [
                “{ \“Google\”: \“aHR0cDovL3d3dy5nb29nbGUuY29t\” }”
              ]
            }
        },
        “styledAsLinks”: {
          “$id”: “#/properties/styledAsLinks”,
          “type”: “boolean”,
          “title”: “The styledAsLinks controls formatting”,
          “description”: “Controls if a content item is display as a link
          (If false item is displayed as a button).”,
          “default”: false,
          “examples”: [
            true
          ]
        }
      }
    },
    “expiryDuration”: {
      “$id”: “#/properties/expiryDuration”,
      “type”: “integer”,
      “title”: “The expiryDuration value”,
      “description”: “Length of time (in seconds) after which this message
      becomes invalid.”,
      “default”: 30,
      “maximum”: 3600,
      “minimum”: 1,
      “examples”: [
        243
      ]
    },
    “highlightedDuration”: {
      “$id”: “#/properties/highlightedDuration”,
      “type”: “integer”,
      “title”: “The highlightedDuration value”,
      “description”: “Length of time (in seconds) to display message on WA
      client UX.”,
      “default”: 10,
      “minimum”: 1,
      “maximum”: 600,
      “examples”: [
        35
      ]
    },
    “timeOfEvent”: {
      “$id”: “#/properties/timeOfEvent”,
      “title”: “The timeOfEvent”,
      “description”: “Date timestamp, UTC time event occurred at Event
Producer. If not supplied, the time the API is called will be used”,
      “anyOf”: [
        {
          “type”: “string”,
          “format”: “date-time”
        },
        {
          “type”: “string”,
          “maxLength”: 0
        }
      ],
      “examples”: [
        “2021-12-09T11:31:05.442Z”,
        “2021-12-09 11:31:05”,
        “2021-12-09 11:31:05Z”,
        “2021-12-09T11:31:05.442+01:00”,
        “2021-12-09T11:31:05.442+0100”,
        “2021-12-09T11:31:05.442−01:00”,
        “2021-12-09T11:31:05.442−0100”,
        “2021-12-09 11:31:05+01:00”,
        “2021-12-09 11:31:05+0100”,
        “2021-12-09 11:31:05−01:00”,
        “2021-12-09 11:31:05−0100”
      ]
    },
    “timeEventDetected”: {
      “$id”: “#/properties/timeEventDetected”,
      “title”: “The timeEventDetected”,
      “description”: “Date timestamp, UTC time event was detected at Event
      Producer.”,
      “anyOf”: [
        {
          “type”: “string”,
          “format”: “date-time”
        },
        {
          “type”: “string”,
          “maxLength”: 0
        }
      ],
      “examples”: [
        “2021-12-09T11:31:05.442Z”,
        “2021-12-09 11:31:05”,
        “2021-12-09 11:31:05Z”,
        “2021-12-09T11:31:05.442+01:00”,
        “2021-12-09T11:31:05.442+0100”,
        “2021-12-09T11:31:05.442−01:00”,
        “2021-12-09T11:31:05.442−0100”,
        “2021-12-09 11:31:05+01:00”,
        “2021-12-09 11:31:05+0100”,
        “2021-12-09 11:31:05−01:00”,
        “2021-12-09 11:31:05−0100”
      ]
    }
  }
```

Below is an example, non-limiting, structure of the notification API. Other notification API structures consistent with the teaching below are considered to be within the scope of the present disclosure and claims.

```
openapi: 3.0.1
components:
  securitySchemes:
    bearerAuth:
      type: http
      scheme: bearer
      bearerFormat: JWT
  schemas:
    notification:
      type: object
      required:
        - upn
        - title
      properties:
        upn:
          type: string
          description: upn is used to define what user the message goes to.
          minLength: 6
          maxLength: 225
          example: daniela.harvey@techco.com
        title:
          type: string
          description: Title of event for display for message.
          minLength: 1
          maxLength: 255
          example: Here I am
        iconType:
          type: string
          description: Icon type to display on an event.
          default: information
          enum: [‘information’, ‘confirmation’, ‘error’, ‘question’, ‘overTalk’, ‘sadFace’, ‘happyFace’, ‘escalation’,
‘clock’]
          example: information
        message:
          type: string
          description: Content message of event to display.
          default: “\”\“”
          minLength: 0
          maxLength: 2000
          example: How do you do
        feedback:
          type: object
          description: Used to configure the feedback of a notification.
          properties:
            positive:
              type: array
              description: Items that will be displayed as positive items on a notification.
              default: [ ]
              items:
                type: string
              example: [‘Good’, ‘Great’, ‘Excellent’]
            negative:
              type: array
              description: Items that will be displayed as negative items on a notification.
              default: [ ]
              items:
                type: string
              example: [‘Bad’, ‘Awful’, ‘Terrible’]
            showFeedback:
              type: boolean
              description: This controls if the up and down feedback buttons are displayed for a notification.
              default: true
              example: true
        actions:
          type: object
          description: Actions that can be displayed on a notification.
          properties:
            content:
              type: array
              items:
                type: string
              example:
                - Google: ‘aHR0cDovL3d3dy5nb29nbGUuY29t’
                - Amazon: ‘aHR0cHM6Ly93d3cuYW1hem9uLmNvbQ==’
              default: [ ]
            styledAsLinks:
              type: boolean
              default: false
              example: true
        expiryDuration:
          type: integer
          format: int32
          description: Length of time (in seconds) after which this message becomes invalid.
          default: 30
          maximum: 3600
          minimum: 1
          example: 300
        highlightedDuration:
          type: integer
          format: int32
          description: Length of time (in seconds) to display message on WA client UX.
          default: 10
          minimum: 1
          maximum: 600
          example: 30
        timeOfEvent:
          type: string
          format: date-time
          description: Date timestamp, UTC time (ISO8601) event occurred at Event Producer. If not supplied,
the time the API is called will be used.
          example: “2021-12-09T11:31:05.442Z”
        timeEventDetected:
          type: string
          format: date-time
          description: Date timestamp, UTC time (ISO8601) event was detected at Event Producer.
          example: “2021-12-09T11:31:05.442Z”
info:
  title: Work Assist REST APIs
  description: Service to send notification to Work Assist cloud service.
  version: “2.0”
  termsOfService: https://www.verint.com/our-company/legal-documents/verintcom-terms-of-service/
  license:
    name: Verint Master Customer Agreement
    url: https://www.verint.com/our-company/legal-documents/end-user-license-agreement/
  # Product Code metadata in Verint Connect Developer Portal
  x-vc-product_code: < Put predefined product code metadata for Verint Connect Developer Portal. List of
available shortcodes - https://community.verint.com/support/nt/kmp/non-technical---
processes/internal/km2244962>
  contact:
    name: API Support
    url: https://community.verint.com/support/
tags:
- name: public
servers:
  - url: https://use1.vcp.verintcloudservices.com/vcp/api/wa/
    description: Verint VCP-US-EAST
  - url: https://apse2.vcp.verintcloudservices.com/vcp/api/wa/
    description: Verint VCP-AU
security:
  - bearerAuth: [ ]
paths:
  /v2/notification:
    post:
      summary: WorkAssist API REST endpoint for sending notifications to WA cloud.
      requestBody:
        required: true
        content:
          application/json:
            schema:
              $ref: ‘#/components/schemas/notification’
      responses:
        ‘200’:
          description: Ok - message processed.
          content:
            text/html; charset=utf-8:
              schema:
                type: string
        ‘400’:
          description: Bad request - missing message, or schema validation failure.
          content:
            text/html; charset=utf-8:
              schema:
                type: string
        ‘401’:
          description: Unauthorized - permissions issue.
          content:
            text/html; charset=utf-8:
              schema:
                type: string
        ‘500’:
          description: Service unavailable - internal error.
          content:
            text/html; charset=utf-8:
              schema:
                type: string
        ‘503’:
          description: Service unavailable - internal error.
          content:
            text/html; charset=utf-8:
              schema:
                type: string
      tags:
- public
```

### Notification Event API Definition

Below is the notification event API definition. In the definition, a Property is an actual event API property. A Source is where the property is added or what is responsible for the property being added before the call is received. Known types are events are internal to the recorder integration server 102 and/or cloud-based recorder 104, and the appropriate HTML rendering to be displayed can be obtained from within an internal HTML server. Unknown events are events received from an unknown source, and the rendered information is either sent without content translation or can be offloaded to a third party for translation on the fly.

The Notification Event API 112 adds raw messages to the managed streaming component 114. A streams processor (within the managed streaming component) reviews raw events, validates them and transforms them into processed events stored into a separate processed topic. The processor can include additional business logic using data from other real-time events when deciding on the appropriate transform. The events within the processed topic are consumed by the client management service. The Client API uses the events from the client management service to render the events within the user interface (FIG. 3B: 318, 320, 322, 324).

| Property | Source | Description | Example, notes |
|---|---|---|---|
| Version/Schema | plugin API | Version of event | this is just the endpoint of the API. Breaking |
| | | Producer. | change versions will use new end points |
| UserUPN | Responsibility | User Principal | Format: user.name@tenantCompany.com |
| | of calling | Name | |
| | component | | |
| TenantAuthorization | VCP | Unique Tenant | generated dynamically during Azure |
| | Authorization | token provided | authentication process |
| | token | by VCP which | |
| | | authenticates call. | |
| | | This can be used | |
| | | by Work Assist | |
| | | (i.e., the real-time | |
| | | contextual event | |
| | | notification | |
| | | system 100) | |
| | | internally to | |
| | | attribute the | |
| | | event to the | |
| | | correct tenant | |
| EventID | Event | a GUID that is | |
| | producer | produced during | |
| | | initial event | |
| | | generation that | |
| | | can be used to | |
| | | track/log the | |
| | | event | |
| | | individually | |
| | | across the | |
| | | product | |
| SourceID | Derived from | A known integer | |
| | XML content: | that denotes the | |
| | Business logic | source of the | |
| | in Kafka | event. Future | |
| | Processor | Authorized event | |
| | | producers will | |
| | | require their own | |
| | | known SourceID | |
| MessageType | WFE | A known | Maps to a list of known message types and |
| | notification | registered type | controls look and feel of message |
| | plugin | (integer) that | |
| | | denotes the type | |
| | | of event being | |
| | | generated. This | |
| | | Type can be used | |
| | | to display Title, | |
| | | Icon, Heading | |
| | | and Messages for | |
| | | specific internal | |
| | | “known” events | |
| | | via localisation | |
| SourceLocale | WFO UX | ISO language | “en-US”, “es-MX”, “fr-CA” |
| | | code. Denotes | |
| | | originating | |
| | | language of | |
| | | source message. | |
| Title | WFO UX | Optional, string. | |
| | | Title of event for | |
| | | display | |
| IconID | WFO UX | Optional. icon ID | This ID will be one of a fixed list of Icons. If |
| | | of event to | outside the bound of the icon list, the default |
| | | display | icon is set |
| Message | WFO UX | Optional. content | User driven content. |
| | | message of event | User is person configuring the notification at |
| | | to display. | customer site |
| Feedback | Kafka | Boolean to | Inferred by feedback lists. Can be property |
| | Processing | denote feedback | of event in Kafka for simple markup check, |
| | | of some kind | but may not be needed within Event API |
| FeedbackOptionsP | WFO UX | Optional. List of | “Thanks”, “Accurate”, “useful”, “Timely” |
| | | Positive | |
| | | Feedback options | |
| | | to be selected | |
| FeedbackOptionsN | WFO UX | Optional. List of | “Spam”, “Inaccurate”, “Annoying”, “Late |
| | | negative | arriving” |
| | | Feedback options | |
| | | to be selected | |
| ButtonList | WFO UX | Optional. List of | “abort”, “retry”, “cancel” |
| | | text to be | If Work Assist is built as DPA compliant |
| | | displayed on | application, then DPA could fire triggers |
| | | work assist UX | based on the buttons clicked as a cheap |
| | | as buttons on | method of feedback and performing desktop |
| | | message | actions |
| | | Clicking the | |
| | | button will | |
| | | attempt a new | |
| | | browser window | |
| | | open at | |
| | | appropriate | |
| | | Button URL | |
| Button UrlList | WFO UX | Optional. List of | “http://blah1”, “http://blah2”, “http://blah”″, |
| | | target URLs to be | White listing within cloud configuration, |
| | | available as | although limited script injection validation is |
| | | buttons on work | handled internally |
| | | assist UX | |
| | | [Subject to | |
| | | whitelist] | |
| ButtonAsLink | WFO UX | Boolean. | Allows render of buttons as html link instead |
| | | Optional | of button |
| | | checkbox. | |
| ExpiryTime | Event | Number of | |
| | Producer | seconds that | |
| | | elapse after | |
| | | which the event | |
| | | is irrelevant | |
| Duration | Event | number of | |
| | Producer | seconds the event | |
| | | may be displayed | |
| | | prominently on | |
| | | UX | |
| TimeOfEvent | Event | datetimestamp, | Some detection systems might be able to |
| | Producer | UTC | distinguish between the time the event |
| | | time event | happened and the time the event was actually |
| | | occurred | |
| TimeEventDetected | Event | datetimestamp, | detected. Other systems may report the same |
| | Producer | UTC | time for both of these properties |
| | | time event was | |
| | | detected | |
| EventUTCOffSet | Event | Timezone offset | |
| | Producer | for the device | |
| | | where the event | |
| | | was detected | |
| TimeEventReceived | Work Assist | datetimestamp, | If this is the API facing WFE or third parties, |
| | API | UTC | then this event received timestamp is |
| | | time event was | generated by the Work Assist server at the |
| | | received by Work | time it receives the API call from WFE. |
| | | Assist | |
| EventPayload | Event | XML source of | full XML payload could be large. In initial |
| | Producer | original payload | design, the payload is sent to kafka for |
| | | | parsing rather than parsed within WFE |
| | | | notification |

### Managed Streaming Component 114

The managed streaming component 114 is a distributed data store optimized for ingesting and processing streaming data in real-time. Streaming data is data that is continuously generated by the sources (for example, 102 and 104), which typically send the data simultaneously. The managed streaming component 114 processes this data and provides the functionalities of publishing and subscribing to streams of records, storing streams of records in the order in which the records were generated, and processing the streams of records in real-time. The managed streaming component 114 combines messaging, storage, and stream processing to allow storage and analysis of both historical and real-time data.

### Client Management System (CMS) 120

The client management system 120 is responsible for delivering the messages provided by topic to the client application 126. The Client Management System (CMS) 120 is a client package that exposes a client API designed to wrap around Socket IO to interact with the managed streaming component 114 to receive/send events. FIG. 4 illustrates a work-flow of the components within the CMS 120 that are communicating with each other according to certain embodiments. FIG. 5A illustrates a general call flow diagram of communication between the notification application executing on the client 124 and Socket.IO Server 411 on the CMS 120 that is shown in FIG. 4 as part of the work-flow according to certain embodiments.

As shown in FIG. 4, the CMS 120 is responsible for consuming events from the managed streaming component topic, sending the events to the appropriate room 408, receiving feedback messages from room 408 as feedback data, and sending feedback messages to the topic, as shown in the sequences of FIG. 4. As shown in FIG. 4, the general work-flow is as follows. Events are delivered to a consumer 404 of the CMS 120 from the managed streaming component 114 related to a topic 402. The consumed events are forwarded to a client manager 406 (for example, the Socket.IO Server 411) that forwards events to the appropriate client application 126a, 126b, 126n using a respective Socket.IO Client 413a, 413b, 413n. The events are delivered using a JavaScript client API 412. Other languages noted herein may be used. The CMS 120 will also take feedback messages from the clients 124a, 124b, 124n to deliver to the topic.

The client manager 406 maintains the list of rooms 408 (i.e., connections 410). The client manager 406 stores the rooms 408 and uses this store of information to route incoming events (from the consumer 404) to the desired connections 410. New connections register with client manager 406 and the client manager 406 will create a room 408 for receiving the events from the clients 124a, 124b, 124n. An Agent ID value is used to store information in room 408. The client manager 406 also manages the lifecycle of the room 408. Each room 408 is responsible for the Socket.IO connection with its respective client 124a, 124b, 124n and contains functionality to send and receive the events from the client 124a, 124b, 124n.

FIG. 5A illustrates how the client API will be situated and used for the various use cases for sending and receiving messages from the Socket IO Server according to certain embodiments. The following general structure may be applied to message objects:

```
{
  string? apiVersion,
  string timestamp,
  object? data, <− where its contents differ from other message types
  object? error
}
```

Event types may be as follows:

From the RIS 204:
i.WorkAssist Messages aka Mentoring Tips aka Notifications=>eventType: ‘notificationEvent’,
ii.Call Start/End/Update=>eventType: ‘callEvent’, From the client 124
iii.Feedback=>eventType: ‘feedbackEvent’,

Below is a non-limiting example message format definition. Other message format definitions consistent with the teaching below are considered to be within the scope of the present disclosure and claims.

```
{
Required: title,upn
upn:
  string minLength:6 maxLength:225
upn is used to define what user the message goes to.
example: daniela.harvey@techco.com
title:
  string minLength:1 maxLength:255
Title of event for display for message.
example: Here I am
iconType:
  string
Icon type to display on an event.
Default: information
Enum: information, confirmation, error, question, overTalk, sadFace,
happyFace, escalation, clock
example: information
message:
  string maxLength:2000
Content message of event to display.
Default: “ ”
example: How do you do
feedback:
  {
Used to configure the feedback of a notification.
positive:
[
Items that will be displayed as positive items on a notification.
string
]
example: Good,Great,Excellent
negative:
[
Items that will be displayed as negative items on a notification.
string
]
example: Bad,Awful,Terrible
showFeedback:
  boolean
This controls if the up and down feedback buttons are displayed for
a notification.
Default: true
example: true
}
actions:
  {
Actions that can be displayed on a notification.
content:
[
string
]
example: [object Object], [object Object]
styledAsLinks:
boolean
example: true
}
expiryDuration:
  integer (int32) minimum:1 maximum:3600
Length of time (in seconds) after which this message becomes invalid.
example: 300
highlightedDuration:
  integer (int32) minimum:1 maximum:600
Length of time (in seconds) to display message on WA client UX.
example: 30
timeOfEvent:
  string (date-time)
Date timestamp, UTC time (ISO8601) event occurred at Event Producer.
If not supplied, the time the API is called will be used.
example: 2021-12-09T11:31:05.442Z
timeEventDetected:
  string (date-time)
Date timestamp, UTC time (ISO8601) event was detected at Event
Producer.
example: 2021-12-09T11:31:05.442Z
}
```

Below is a non-limiting example message format. Other notification message formats consistent with the teaching below are considered to be within the scope of the present disclosure and claims.

{
“upn”: “Benjamin.Keeling15@gmail.com”,
“title”: “Liaison AI Metal Cambridgeshire International”,
“iconType”: “sadFace”,
“message”: “Outdoors haptic connect Music Web Graphic Iowa
infomediaries Aruban synthesize”,
“feedback”: {
“positive”: [
“harness”,
“XSS”,
“Peru”,
“RAM”,
“next-generation”,
“Yen”
],
“negative”: [
“invoice”,
“Uruguay”,
“Tasty”,
“Berkshire”,
“Tasty”,
“process”
],
“showFeedback”: true
},
“actions”: {
“content”: [
{
“navigate”: “aHR0cDovL3JvZG9sZm8ub3Jn”
},
{
“Amazon2”: “aHR0cHM6Ly93d3cuYW1hem9uLmNvbQ==”
},
{
“Cambridgeshire”: “aHR0cDovL2pveS5jb20=”
},
{
“Goggle”: “aHR0cDovL3d3dy5nb29nbGUuY29t”
}
],
“styledAsLinks”: true
},
“expiryDuration”: 564,
“highlightedDuration”: 33,
“timeOfEvent”: “2022-02-02T17:31:36.619Z”,
“timeEventDetected”: “2022-02-02T17:31:56.619Z”
}

### Client Application 126

The client application 126 may include a wrapper built using, for example, the Electron chromium browser application and a React JavaScript application. As such, the client application 126 may be cross-platform and may run on various different clients 124 having different operating systems, display areas, and processors, so long as they are capable of executing a browser application. The wrapper provides operating system functionality, such as, always in focus, ‘stickyness’ and pass through to system notifications when minimized. The React application inside the wrapper is structured by defining components, such as screen components, user interface (UI) components and atom components. The screen components define the visible page that is displayed to an end-user (src/pages). The UI components are the building blocks of the displayed pages (src/components). The atom components are simple components not specific to event notification (src/components/atoms).

### Screen Components

The screen components are components of the client application 126, which uses the various UI components as building blocks to build the screens the user sees and interacts with. An example definition is as follows:

FIG. 5B is an operational example depicting a graphical user interface (GUI) 500 in accordance with certain embodiments described herein. A user (e.g., supervisor) can use the GUI 500 to monitor a plurality of agents and take corrective actions as needed.

As illustrated, the GUI 500 displays interaction cards 501a-1 showing real-time events for interactions associated with a plurality of agents (e.g., employees) in a team view area. As illustrated, selecting a first interaction card 501a associated with a first agent causes display of a timeline including one or more interactions including any alerts 502, 504 associated with the first agent. Interaction cards 501a-1 can display ongoing or ended interactions and can include agent information (e.g., name, current interaction details including duration, alert information). An ended interaction may be grayed out. When an agent begins a new interaction, the information on their interaction card is replaced by the current interaction's information. Interactions/interaction cards can be categorized as positive (e.g., interaction card 501f) or negative (e.g., interaction card 501b). The status of an interaction card can change based on the progression of given interaction (e.g., green flag/color to red flag/color).

FIG. 5C is another operational example showing an expanded view of an interaction card 501b that includes an interaction status, agent name, customer information, interaction information (start time, duration, timeline), and work assist notification. In the example shown in FIG. 5C, four rows are shown where each row corresponds with a work assist notification alert category that occurred during the interaction and the alert message received by the agent.

The CMS 120 can provide a bridge to all employees that are relevant to a logged in user and ensures that the visualization data is an aggregated view from all relevant event streams. The call view can display different real-time event streams available within the cloud data steam such that each event has its own swim lane to distinguish it. Real-time event streams can include speech and transcription, sentiment analysis, non-verbal cues, biometric analysis, desktop activity, knowledge notifications, alerts/alarms associated with an ongoing interaction, and combinations thereof. In some examples, the swim lane view can be collapsed to enable all events to be shown in a single view. The call view can use data obtained from the RIS 204 to look up additional data services for a given interaction, such as a playback screen or audio listen in functionality. In various implementations, the ability to subscribe to visualized events enables a notification-led, proactive approach to managing employees who may be encountering difficulties in customer interactions, whether they are remote or co-located with a supervisor. The system also facilitates direct integration of legacy system data that may be stored in a variety of locations (e.g., on premise components, cloud-based data).

As illustrated in FIG. 5B, cach ongoing interaction 502, 504 is shown as a selectable user interface object that is selectable to enable various direct actions such as filtering or sorting operations. In some examples, selection of a single interaction 502, 504 in the team view can cause the GUI 500 to switch to a call view for the selected interaction.

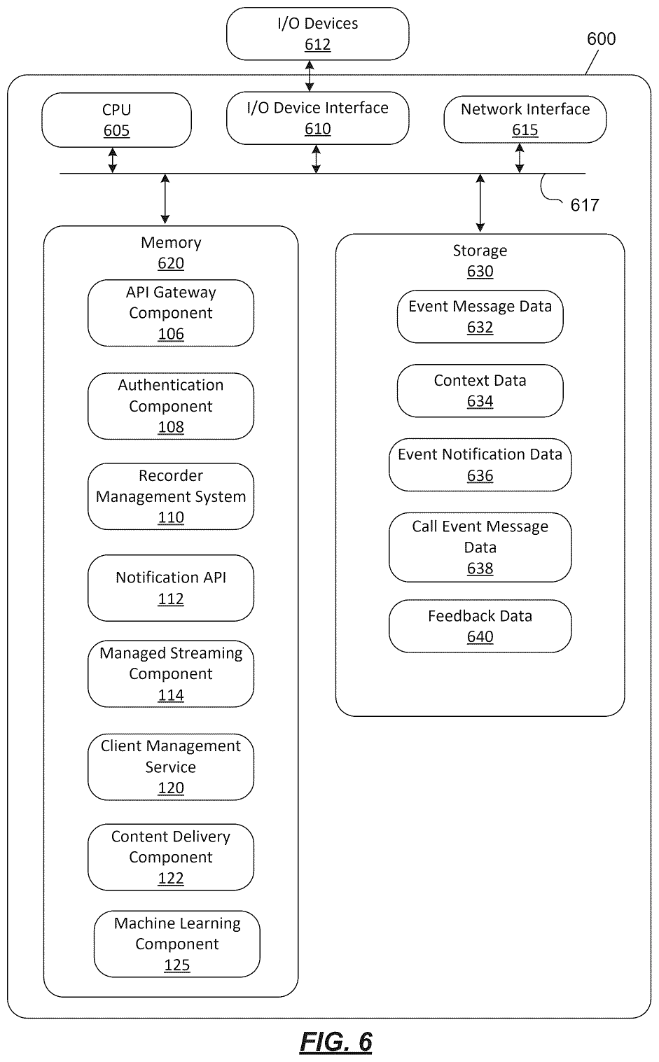

FIG. 6 illustrates an example computing system 600 that may include the kinds of software programs, data stores, and hardware that can implement event message processing, context determination, notification generation, and content delivery, as described above according to certain embodiments. As shown, the computing device 600 includes, without limitation, a central processing unit (CPU) 605, a network interface 615, a memory 620, and storage 630, each connected to a bus 617. The computing system 600 may also include an I/O device interface 610 connecting I/O devices 612 (e.g., keyboard, display and mouse devices) to the computing system 600. Further, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stored in the storage 630. The bus 617 is used to transmit programming instructions and application data between the CPU 605, I/O device interface 610, storage 630, network interface 615, and memory 620. Note, CPU 605 is included to be representative of a single CPU, multiple CPUs, a single CPU having multiple processing cores, and the like, and the memory 620 is generally included to be representative of a random access memory. The storage 630 may be a disk drive or flash storage device. Although shown as a single unit, the storage 630 may be a combination of fixed and/or removable storage devices, such as fixed disc drives, removable memory cards, optical storage, network attached storage (NAS), or a storage area-network (SAN).

Illustratively, the memory 620 includes an API gateway component 106, an authentication component 108, a recorder management system 110, a notification API component 112, a managed streaming component 114, a client management system 114, a content delivery component 122, and a machine learning component 125, all of which are discussed in greater detail above. Further, storage 630 includes, event message data 632, context data 634, event notification data 636, call event message data 638, and feedback data 640, all of which are also discussed in greater detail above.

### Machine Learning

This disclosure contemplates that the exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, cach layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, lincar, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail hercin.

A convolutional neural network (CNN) is a type of deep neural network that has been applied, for example, to image analysis applications. Unlike traditional neural networks, cach layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Thus, the real-time contextual event notification system 100 of the present disclosure ingests events as streams from any authorized entity, applies rules to the event streams, determines a context of a support agent, and blends the rules and context to provide notifications to the support agent in accordance with the context.

What is claimed:

1. A method of visualizing real-time contextual event notifications, comprising:
receiving, at an Application Programming Interface (API) gateway component, event messages related to interactions between entities;
processing, at a managed streaming component, the event messages to determine a context to generate event notifications;
labeling the event notifications; and
presenting, in a user interface, event notifications and labels, wherein the event notifications and labels are used to monitor or intervene in interactions between the entities.

2. The method of claim 1, further comprising scoring the event notifications and presenting scored event notifications as visual icons.

3. The method of claim 1, further comprising subscribing to the event notifications.

4. The method of claim 1, further comprising enabling an entity to listen to an interaction.

5. The method of claim 1, further comprising enabling an entity to view a desktop screen of an interaction.

6. The method of claim 1, further comprising enabling an entity to review a textual categorization of an interaction.

7. The method of claim 1, further comprising enabling an entity to review a dynamic, textual transcript of an interaction.

8. The method of claim 7, further comprising enabling an entity to jump to any point in the textual transcript based on phrases and textual categorizations detected.

9. The method of claim 7, further comprising enabling an entity to review a textual summary of an interaction, wherein the textual summary is provided via artificial intelligence inference of the textual transcript.

10. The method of claim 1, further comprising enabling an entity to classify interactions based on the different event streams presented.

11. The method of claim 10, further comprising enabling an entity to filter and sort the interactions based on the classifications.

12. A system comprising:
at least one processor; and
a memory operably coupled to the at least one processor, the memory having computer-executable instructions stored thereon that, when executed by the at least one processor, cause the system to:
receive, at an API gateway component, event messages related to interactions between entities;
process, at a managing streaming component, the event messages to determine a context to generate event notifications;
label the event notifications; and
present, at a user interface, event notifications and labels, wherein the event notifications and labels are used to monitor or intervene in interactions between entities.

13. The system of claim 12, further comprising computer-executable instructions that when executed by the at least one processor, cause the system to:
score the event notifications and present scored event notifications as visual icons.

14. The system of claim 12, further comprising computer-executable instructions that when executed by the at least one processor, cause the system to:
subscribe to the event notifications.

15. The system of claim 12, further comprising computer-executable instructions that when executed by the at least one processor, cause the system to:
enable an entity to listen to an interaction.

16. The system of claim 12, further comprising computer-executable instructions that when executed by the at least one processor, cause the system to:
enable an entity to view a desktop screen of an interaction.

17. The system of claim 12, further comprising computer-executable instructions that when executed by the at least one processor, cause the system to:
enable an entity to review a textual categorization of an interaction.

18. The system of claim 12, further comprising computer-executable instructions that when executed by the at least one processor, cause the system to:
review a textual categorization of an interaction, a textual summary of an interaction, and/or review a dynamic, textual transcript of an interaction, wherein the textual categorization, the textual summary and/or the dynamic textual transcript is provided via artificial intelligence inference of the interaction or textual transcript.

19. The system of claim 18, further comprising computer-executable instructions that when executed by the at least one processor, cause the system to:
enable an entity to jump to any point in the textual transcript based on phrases and textual categorizations detected.

20. A non-transitory computer readable medium comprising instructions that, when executed by a processor of a processing system, cause the processing system to perform a method for processing an audio input, comprising instructions to:
receive, at an API gateway component, event messages related to interactions between entities;
process, at a managing streaming component, the event messages to determine a context to generate event notifications;
label the event notifications; and
present, at a user interface, event notifications and labels, wherein the event notifications and labels are used to monitor or intervene in interactions between entities.
